(19) United States
(12) Patent Application Publication
(10) Pub. No.: US 2016/0187864 A1
(43) Pub. Date: Jun. 30, 2016

(54) Apparatus and System for Providing Energy Information

(71) Applicant: ENCORED TECHNOLOGIES, INC., Seoul (KR)

(72) Inventors: Jong-Woong Choe, Seoul (KR); Hyunsu Bae, Seoul (KR); Junhan Ahn, Seoul (KR)

(73) Assignee: Encored Technologies, Inc., Seoul (KR)

(21) Appl. No.: 14/911,146

(22) PCT Filed: Aug. 12, 2014
(86) PCT No.: PCT/KR2014/007468

§ 371 Date: Feb. 9, 2016

(30) Foreign Application Priority Data
Aug. 12, 2013 (KR) 10-2013-0095421

(51) Int. Cl. G05B 19/048

(52) U.S. Cl. CPC G05B 19/048; G05B 2219/2639

(57) ABSTRACT

The present invention relates to an apparatus for providing energy information, including: an energy information input unit configured to receive energy information for each device extracted from combined energy information according to a classification of the device using collected energy-related information; an energy information processing unit configured to generate energy use information of the device by using the energy information for each device; and an energy information transmitting unit configured to transmit the generated energy use information to a user terminal According to the present invention, it is possible to improve data stability by processing and managing cloud data by an energy information provider, and continuously improve performance through an upgrade of software and a database. Furthermore, it is possible to eliminate burden of initial investment and maintenance costs for all other devices and equipment to a user in addition to an energy monitoring device, and it is also possible to reduce the burden of learning expert knowledge on big data processing and information interpretation and of having separate permanent managing personnel by allowing cloud-based energy information management by professionals.

### TECHNICAL FIELD

The present invention relates to an apparatus for providing energy information, and more particularly, to an apparatus for processing energy information based on a cloud.

### BACKGROUND

A method for processing energy information collected through an energy monitoring device, which is mainly used in the related art, is to display information through a display screen or a computer monitor of a local control center, other dedicated gateways, and display devices (an IHD and the like) by autonomously establishing a local server in a space, in which energy information is collected, or separately installing dedicated software in a pre-installed computer and the like.

The prior document (Korean Patent No. 10-1068862) discloses a system for managing energy through monitoring in real time, which is capable of most efficiently managing energy by monitoring, data-forming, analyzing, and supplying energy consumed in a building for each usage by synchronizing respective sensors for electricity, water supply, gas, cooling/heating, and the like.

However, the system has a limit in updating software and a database for processing and managing mass energy information, and due to a limit in expert knowledge of a user, an active energy saving effect through energy information is decreased and burden of an increase in an initial equipment investment for every device and an increase in incidental costs according to maintenance and repair is increased.

### SUMMARY OF THE INVENTION

In order to solve the aforementioned technical problems, the present invention suggests a method for displaying energy information processing based on a cloud through a display, in which energy information collected by an energy monitoring device is transmitted to a cloud platform of an energy IT expert service company and is continuously data-processed and managed by professionals, thereby decreasing burden to a user, and a service provider transmits energy information of each user to an information displaying site or an application, a cable TV, an IPTV, a VAN POS, and the like, so that a user may check energy information in real time by a simple access through a smart device of the user and easily access professional energy saving consulting transmitted through a text message and a subtitle provided by the service provider, an energy dedicated channel, and the like.

### Technical Solution

In order to solve the technical problem, an exemplary embodiment of the present invention provides an apparatus for providing energy information, including: an energy information input unit configured to receive energy information for each device extracted from combined energy information according to a classification of the device using collected energy-related information; an energy information processing unit configured to generate energy use information of the device by using the energy information for each device; and an energy information transmitting unit configured to transmit the generated energy use information to a user terminal.

The device may be classified according to a predetermined attribute of the device through a sampling process using the energy-related information, and the energy information for each device may be extracted from information on a total power energy of a combination of a plurality of devices according to the classification of the device.

The device may transmit an identification code for identifying the device during a use of energy to an energy-related information collecting apparatus, and the energy-related information collecting apparatus may classify the device according to the identification code.

The energy information processing unit may generate energy use information for each group, which is formed of a plurality of devices using the energy, by using the energy information for each device.

The energy information processing unit may generate information on a device operation state by recognizing a change in a power use pattern of the device by using the energy information for each device.

The energy information processing unit may recognize a user behavior pattern formed by each device or a combination of the devices by using the energy information for each device, and generate the energy use information through the recognized behavior pattern.

The apparatus may further include an energy information storing unit configured to make the energy-related information, the combined energy information, and the energy information for each device into a database and store the information, in which the energy information processing unit may generate the energy use information by using the energy-related information, the combined energy information, and the energy information for each device received from the energy information storing unit.

In order to solve the technical problem, another exemplary embodiment of the present invention provides a system for processing energy information, including: an energy-related information collecting apparatus configured to collect energy-related information, and extract energy information for each device from combined energy information by classifying the device by using the collected energy-related information; an energy information providing apparatus configured to generate energy use information of the device by using the extracted energy information for each device and transmit the generated energy use information to a user terminal; and the user terminal configured to receive the energy use information and display the received energy use information to a user.

In order to solve the technical problem, still another exemplary embodiment of the present invention provides a user terminal, including: a receiving unit configured to receive energy use information of a device generated by using energy information for each device extracted from combined energy information according to a classification, according to a classification of the device using collected energy-related information; and a display unit configured to display the received energy use information to a user.

In order to solve the technical problem, yet another exemplary embodiment of the present invention provides an apparatus for collecting energy-related information, including: an energy-related information collecting unit configured to collect energy-related information; a device-based energy information extracting unit configured to extract energy information for each device from combined energy information by classifying the device by using the collected energy-related information; and a transmitting unit configured to transmit the extracted energy information for each device to an energy information providing apparatus for providing energy use information.

### Advantageous Effects

According to the present invention, it is possible to improve data stability by processing and managing cloud data by an energy information provider, and continuously improve performance through an upgrade of software and a database. Furthermore, it is possible to eliminate burden of initial investment and maintenance costs for all other devices and equipment to a user in addition to an energy monitoring device, and it is also possible to reduce the burden of learning expert knowledge on big data processing and information interpretation and of having separate permanent managing personnel by allowing cloud-based energy information management by professionals. Further, it is possible to provide real-time energy information and professional energy saving consulting through an energy IT professional service organization, thereby enabling a user to actively and voluntarily participate in an energy saving market based on the energy information utilizing the received real-time energy information and professional energy saving consulting.

### DESCRIPTION OF DRAWINGS

FIG. 1 is a concept diagram illustrating a system for providing energy information according to an exemplary embodiment of the present invention.

FIG. 2 is a block diagram illustrating an energy-related information collecting apparatus according to an exemplary embodiment of the present invention.

FIG. 3 is a block diagram illustrating an energy information providing apparatus according to an exemplary embodiment of the present invention.

FIG. 4 is a block diagram illustrating a user terminal according to an exemplary embodiment of the present invention.

FIG. 5 is a flowchart illustrating a method for providing energy information according to an exemplary embodiment of the present invention.

### DETAILED DESCRIPTION

The following description illustrates only a principle of the present invention. Accordingly, a person skilled in the art invent various apparatuses implementing the principle of the invention and included in a concept and a scope of the invention though the apparatuses are not clearly described or illustrated in the present specification. It should be further understood that all conditional terms and exemplary embodiments which are described in the specification are intended to understand the concept of the invention but the present invention is not limited to the exemplary embodiments and states specifically described in the specification.

The aforementioned objects, characteristics, and advantages will be more apparent through the detailed description below related to the accompanying drawings, and thus those skilled in the art to which the present invention pertains will easily carry out the technical spirit of the present invention. Further, in the following description, a detailed explanation of a publicly known technology related to the invention may be omitted when it is determined that the detailed explanation may unnecessarily obscure the subject matter of the present invention. Hereinafter, an exemplary embodiment according to the present invention will be described in detail with reference to the accompanying drawings.

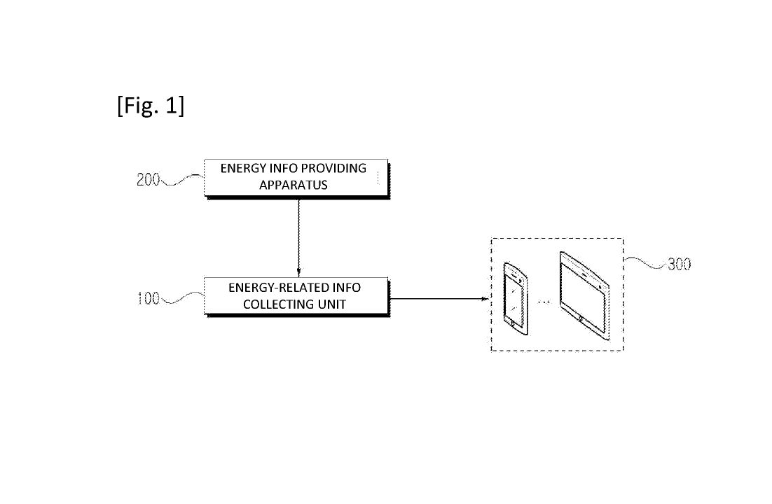

FIG. 1 is a concept diagram illustrating a system for providing energy information according to an exemplary embodiment of the present invention.

Referring to FIG. 1, the system for providing energy information according to the present exemplary embodiment includes an energy-related information collecting apparatus 200, an energy information providing apparatus 100, and a user terminal 300.

In the present exemplary embodiment, the energy-related information collecting apparatus 200 transmits energy information for each device extracted from combined energy information to the energy information providing apparatus 100 according to a classification of a device using energy-related information collected in a cloud computing environment.

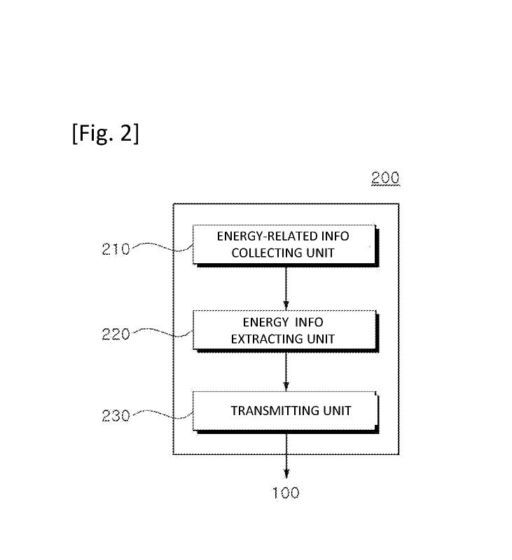

Referring to FIG. 2, the energy-related information collecting apparatus 200 includes an energy-related information collecting unit 210, an energy information extracting unit 220, and a transmitting unit 230.

The energy-related information collecting unit 210 collects energy-related information. That is, the energy-related information collecting unit 210, which is a device for measuring a voltage, a current, and the like by utilizing automatic meter reading (AMR), an advanced metering infrastructure (AMI), a current transformer(CT)/potential transformer (PT), or the like, directly measures and stores a unique waveform by high-speed sampling voltage and current information through a watt-hour meter, a smart meter, a CT/PT, and the like inserted into a power distributor within a building or installed in a feeder branch.

The energy information extracting unit 220 extracts information about a power supply and consumption state and a power analysis through the collected energy related information. The corresponding device is equipped with an analog-digital converter, a flash memory, a microprocessor, or a digital signal processor for the extraction, and includes an embedded system algorithm for extracting energy information from the measured voltage and current waveform.

In the present exemplary embodiment, the embedded system algorithm for extracting energy information classifies a device by using the collected energy related information, and extracts energy information for each device from combined energy information.

More particularly, the device is classified by adding a high speed data sampling function to the energy monitoring device installed in the watt-hour meter, such as an AMI or an AMR, or the entire distributor or for each branch circuit of the distributor.

Further, in the present exemplary embodiment, the energy-related information contains basically collected information on a voltage, a current, active power, reactive power, instantaneous power, a power factor, a frequency, and the like, and additional information, such as harmonic wave, noise, a transient state, and a normal state of the voltage and the current itself, and the energy information extracting unit 220 classifies the device by utilizing the information, which may be additionally utilized through the high-speed sampling.

The combined energy information is target information for extracting energy information for each device, and may be determined according to a unit (for example, a building or a region) managed by the system for providing energy information according to the present exemplary embodiment. That is, a device having a unique characteristic is sequentially separated from entire measured power energy information measured for the unit to finally classify a plurality of individual devices.

Otherwise, an energy information code, such as an operation mode and a defect mode, in addition to on/off, of a corresponding device is transmitted to the energy monitoring device, such as an AMI, an AMR, and a distributor/branch circuit, through communication whenever energy is used by inserting a code, based on which it is possible to recognize a device from individual electric devices later, into a power energy using device, and individual devices are actively classified based on the entire power energy information measured by the energy monitoring device, which utilizes the energy information code, without a separately additional hardware device to extract energy information about the individual device from the entire measured power energy information by a combination of the individual devices.

The transmitting unit 230 transmits data, which is measured through a wired/wireless communication device installed in the device and a corresponding network and is not processed, and various energy information, which is signal-processed by a power analysis algorithm, to the energy information providing apparatus 100, which is to be described below.

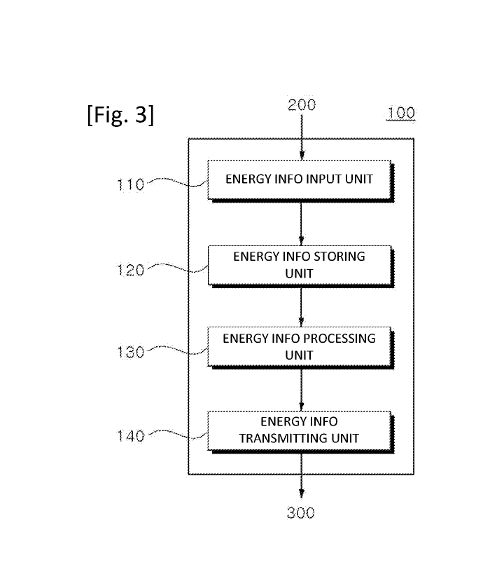

In the present exemplary embodiment, the energy information providing apparatus 100 may generate energy use information about a device by using the extracted energy information for each device and transmit the generated energy use information to the user terminal 300, and may be implemented through an open energy IT platform (OEIP) based on a cloud. Referring to FIG. 3, the energy information providing apparatus 100 includes an energy information input unit 110, an energy information storing unit 120, an energy information processing unit 130, and an energy information transmitting unit 140.

The energy information input unit 110 classifies a device by using the collected energy-related information, and receives the energy information for each device extracted from the combined energy information according to the classification. That is, the energy information input unit 110 effectively receives the energy information transmitted from the plurality of energy-related information collecting apparatuses 200 in a cloud platform, and simultaneously monitors whether the energy-related information collecting apparatus 200 normally communicates, a device defect, and the like, and transmits the voltage, the current waveform, and the energy information transmitted from the energy-related information collecting apparatus 200 to the energy information storing unit 120 in sequence or in parallel.

The energy information storing unit 120 makes the energy-related information, the combined energy information, and the energy information for each device into a database and stores the information. That is, the energy information storing unit 120 appropriately stores the various information collected through the energy information input unit 110 according to a configuration of a data map of a previously designed database, and backs up important data. An energy-related expert group analyzes a condition, utility, and efficiency of an energy generation/consumption activity generated within a building, in which the specific energy-related information collecting apparatus 200 is installed, by mainly utilizing the corresponding data.

Further, the information of the corresponding database is linked to the energy information processing unit 130, which is for the purpose of providing easy and useful energy information so that customers of a general energy non-expert group, in which the energy-related information collecting apparatus 200 is installed, may easily understand the energy information and actively participate in an energy saving activity.

The energy information processing unit 130 generates energy use information about a device by using the energy information for each device. That is, based on data linked in the database, the energy information processing unit 130 extracts information, such as a real-time entire power use amount, a power use amount for each device, and an accumulated power use amount, directly useful to a user of the energy-related non-expert group, interprets a data of the energy expert group, such as an energy IT professional service provider, compares power use amounts between mutually similar groups generated through an analysis algorithm, and generates various processed high-quality information, such as a device defect, an energy saving method, and a behavior pattern.

The energy use information generated by the energy information processing unit 130 according to the present exemplary embodiment contains information on energy consumption amounts between mutually similar groups, such as the same industry field and a similar building. That is, it is possible to easily provide statistical information without leakage of personal information by collectively managing the energy information by a professional service provider possessing an energy platform, and it is possible to generate a voluntary competitiveness factor between users through the statistical information, thereby being utilized as an efficient tool for saving energy.

Further, the energy use information contains sensing information obtained by sensing whether a device is defective and abnormal. That is, whether a device is defective and abnormal is sensed based on whether a power use pattern characteristic of an individual device is sharply changed, and the sensing result may be utilized for analyzing economic feasibility according to a device repair in advance and new device introduction, so that it is possible to consult high-quality information. Further, the energy use information may contain information, which is helpful to select a user device through a comparison between the same kind of models or is capable of notifying a device change time, and additional information notifying a government organization, which is capable of determining a policy, of a device among specific individual devices, for which it is better to establish a high-efficient energy policy in terms of the entire power energy consumption.

Further, the energy information processing unit 130 estimates a unique behavior pattern of a user formed by an operation of an individual device or a combination of the individual devices as additional information, generates high-quality information about the energy information to a specific place at main activity times of the users through the estimated unique behavior pattern of the user and consults the high-quality information, so that it is possible to effectively induce a variation of a behavior pattern for saving energy. Further, the high-quality information, which may be estimated based on a change in individual device use patterns of physically weak people, such as seniors and disabled people, may also be utilized as a personal protection assistant means for physically weak people.

The energy information transmitting unit 140 transmits the various generated user friendly energy information as various forms of big data based on a wired/wireless network in sequence or in parallel in order to perform a subordinate or interconnected service appropriate to service models required by various user terminals 300, and checks whether communication is normal and the like according to the transmission of the corresponding information.

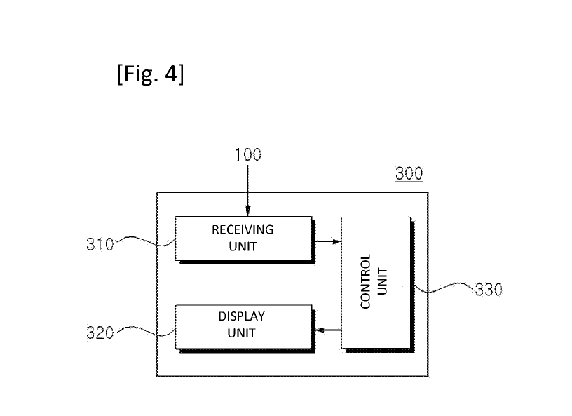

The user terminal 300 receives the energy use information and displays the received energy use information to a user. Referring to FIG. 4, the user terminal 300 according to the present exemplary embodiment includes a receiving unit 310, a display unit 320, and a control unit 330.

The receiving unit 310 classifies a device by using the collected energy-related information, and receives the energy use information about the device generated by using the energy information for each device extracted from the combined energy information according to the classification.

The display unit 320 displays the received energy use information to the user. In the present exemplary embodiment, in displaying, by the display unit 320, the energy use information, the control unit 330 may be mounted with a user application implementing an energy non-expert group friendly user interface for transmitting easy and useful energy information in real time according to a service model, which a user customer prefers and desires to receive within a building, in which the energy-related information collecting apparatus 200 is installed.

That is, in the present exemplary embodiment, as the service model for providing the energy use information, a web support service, an app support service, a text message support service, a cable TV/IPTV support service, and a VAN/POS support service may be provided.

The app support service is a user interface display service providing model, in which an energy IT professional business operator displays energy information and energy saving consulting information in real time when a user customer sets an account/password by accessing a dedicated application under a portable smart device environment.

The text message support service is a user interface display service providing model, in which an energy IT professional business operator displays specific energy information and energy saving consulting information whenever an event situation is generated by a contract with a user customer. The cable TV/IPTV support service is a model, in which an energy IT professional business operator provides energy information and energy saving consulting information through a real-time subtitle service or a pop-up of an event situation when a user utilizes the device, and when the user performs a user manipulation in response to the received information, a user interface display service is provided through an energy-related dedicated channel

That is, in the present exemplary embodiment, the user terminal 300 may display the energy information to various user friendly display devices through a cable TV, an IPTV, a VAN POS, and the like, in addition to the existing access of the energy information through a web and an application, by displaying the energy information based on a cloud, and design/establish a DB and a system for intellectualized and automated energy saving consulting and simplify/geometricize and suggest energy saving consulting/solution contents based on a user, so that it is possible to provide information through the monitoring and induce the user to initiatively participate in an energy saving activity by himself/herself.

Further, the user terminal 300 may provide various applications and services, such as a virtual simulation and an application of a game rule, according to an energy saving rate so that a user performs an energy saving activity by himself/herself, beyond a level of a fee payment for the total energy use amount, so that it is possible to induce the user to voluntarily participate in the energy saving activity and change a behavior pattern.

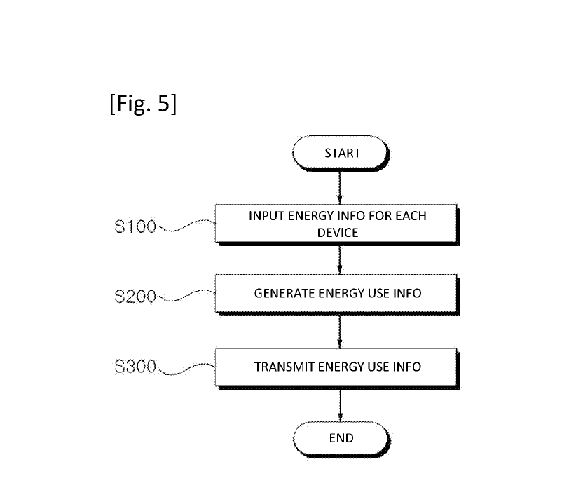

Hereinafter, a method for providing energy information performed by the aforementioned apparatus 100 for providing energy information according to the exemplary embodiment will be described. Referring to FIG. 5, the method for providing energy information according to the present exemplary embodiment includes an energy information input operation S100, an energy use information generating operation S200, and an energy use information transmitting operation S300.

In the energy information input operation S100, the energy information input unit 110 classifies a device by using collected energy-related information, and receives energy information for each device extracted from combined energy information according to the classification.

In the energy use information generating operation S200, the energy information processing unit 130 generates energy use information about a device by using the energy information for each device.

In the energy use information transmitting operation S300, the energy information transmitting unit 140 transmits the generated energy use information to the user terminal 300.

Meanwhile, the method for collecting the energy-related information of the present invention may be implemented by a computer-readable code in a computer-readable recording medium. The computer-readable recording medium includes all kinds of recording devices in which data readable by a computer system is stored.

Examples of the computer-readable recording medium include a ROM, a RAM, a CD-ROM, a magnetic tape, a floppy disk, or an optical data storage device, and in the computer-readable recording medium, a code, which is distributed in computer systems connected through a network and is readable by a computer in a distributed manner, may be stored and executed. Further, a functional program, code, and code segment for implementing the present invention may be easily deduced by a programmer in a technical field to which the present invention belongs.

The above description is simply given for illustratively describing the technical spirit of the present invention, those skilled in the art will appreciate that various modifications, changes and substitutions are possible, without departing from the essential characteristic of the present invention.

Accordingly, the exemplary embodiment disclosed in the present invention and the accompanying drawings are not intended to limit but describe the technical spirit of the present invention, and the scope of the technical spirit of the present invention is not limited by the exemplary embodiment and the accompanying drawings. The scope of the present invention shall be interpreted by the appended claims and it shall be interpreted that all of the technical spirits in the equivalent range are included in the scope of the present invention.

1. An apparatus for providing energy information, comprising:
an energy information input unit configured to receive energy information for each device extracted from combined energy information according to a classification of the device using collected energy-related information;
an energy information processing unit configured to generate energy use information of the device by using the energy information for each device; and
an energy information transmitting unit configured to transmit the generated energy use information to a user terminal.

2. The apparatus of claim 1, wherein the device is classified according to a predetermined attribute of the device through a sampling process using the energy-related information, and
the energy information for each device is extracted from a total amount of power energy of a combination of a plurality of devices according to the classification of the device.

3. The apparatus of claim 1, wherein the device transmits an identification code for identifying the device during a use of energy to the energy-related information collecting apparatus, and
the energy-related information collecting apparatus classifies the device according to the identification code.

4. The apparatus of claim 1, wherein the energy information processing unit generates energy use information for each group, which is formed of a plurality of devices using the energy, by using the energy information for each device.

5. The apparatus of claim 1, wherein the energy information processing unit generates information on a device operation state by recognizing a change in a power use pattern of the device by using the energy information for each device.

6. The apparatus of claim 1, wherein the energy information processing unit recognizes a user behavior pattern formed by each device or a combination of the devices by using the energy information for each device, and
generates the energy use information through the recognized behavior pattern.

7. The apparatus of claim 1, further comprising:
an energy information storing unit configured to make the energy-related information, the combined energy information, and the energy information for each device into a database and store the information,
wherein the energy information processing unit generates the energy use information by using the energy-related information, the combined energy information, and the energy information for each device received from the energy information storing unit.

8. A system for processing energy information, comprising:
an energy-related information collecting apparatus configured to collect energy-related information, and extract energy information for each device from combined energy information by classifying the device by using the collected energy-related information;
an energy information providing apparatus configured to generate energy use information of the device by using the extracted energy information for each device and transmit the generated energy use information to a user terminal; and
the user terminal configured to receive the energy use information and display the received energy use information to a user.

9. A user terminal, comprising:
a receiving unit configured to receive energy use information of a device generated by using energy information for each device extracted from combined energy information according to a classification of the device using collected energy-related information; and
a display unit configured to display the received energy use information to a user.

10. An apparatus for collecting energy-related information, comprising:
an energy-related information collecting unit configured to collect energy-related information;
a device-based energy information extracting unit configured to extract energy information for each device from combined energy information by classifying the device by using the collected energy-related information; and
a transmitting unit configured to transmit the extracted energy information for each device to an energy information providing apparatus for providing energy use information.

11. The apparatus of claim 10, wherein the device-based energy information extracting unit classifies the device according to a predetermined attribute of the device through a sampling process using basic energy information containing collected voltage, current, and power information and additional energy information containing information on harmonic wave, noise, a transient state, and a normal state of the voltage and the current itself.

12. The apparatus of claim 10, wherein the device transmits an identification code for identifying the device during a use of energy to the energy-related information collecting apparatus, and
the device-based energy information extracting unit classifies the device according to the identification code.

13. A method for providing energy information, comprising:
receiving energy information for each device extracted from combined energy information according to a classification of the device using collected energy-related information;
generating energy use information of the device by using the energy information for each device; and
transmitting the generated energy use information to a user terminal.

14. The method of claim 13, wherein the device is classified according to a predetermined attribute of the device through a sampling process using the energy-related information, and
the energy information for each device is extracted from a total amount of power energy of a combination of a plurality of devices according to the classification of the device.

15. The method of claim 14, wherein the device transmits an identification code for identifying the device during a use of energy to the energy-related information collecting apparatus, and
the energy-related information collecting apparatus classifies the device according to the identification code.
